(19) United States
(12) Patent Application Publication
(10) Pub. No.: US 2012/0268593 A1
(43) Pub. Date: Oct. 25, 2012

(54) Surveillance Monitor

(75) Inventor: Jian Ma, Luo Yang City (CN)

(73) Assignee: Luoyang Ruiguang Movie-Tv Optic-Electronic Technology Co., Ltd., Luo Yang City (CN)

(21) Appl. No.: 13/330,700

(22) Filed: Dec. 20, 2011

(30) Foreign Application Priority Data
Apr. 21, 2011 (CN) 201120119648.2
Apr. 21, 2011 (CN) 201120119649.7

(51) Int. Cl. H04N 7/18

(52) U.S. Cl. 348/143; 348/E07.085

(57) ABSTRACT

A surveillance monitor includes a monitor assembly and a control hub. The monitor assembly includes at least one display unit for displaying a predetermined image. The control hub includes a control housing and a control module. The control housing is positioned at a distance from the monitor assembly. The control module is electrically communicated with the monitor assembly, wherein the control module comprises a central processing unit and a control panel provided on the control housing, wherein the central processing unit is arranged to process video signals, and transmit the processed video signal to the monitor assembly for generating a corresponding video image on the monitor assembly, so that a user is able to control video display on the monitor assembly by conveniently controlling the control module which is distant away from the monitor assembly.

### BACKGROUND OF THE PRESENT INVENTION

1. Field of Invention

The present invention relates to a monitor, and more particularly to a surveillance monitor wherein a monitor assembly and a control hub thereof are positioned at a distance so as to allow convenient control of the surveillance monitor.

2. Description of Related Arts

A conventional surveillance monitor usually comprises a housing, a display screen mounted in the housing, a central processing unit and a power supply. The central processing unit usually comprises a video processing module, an audio processing module, and a control module. Conventionally, the central processing unit, the power supply, and the display screen are all mounted in the housing to form an integral body of the conventional surveillance monitor.

There are several disadvantages in association with this conventional surveillance monitor. First, when the surveillance monitor is operating, many of its components, such as the display screen and the video processing module, will release a large amount of heat which may cause overheat problems to all the components mounted in the housing. The situation becomes worse when the size of the display screen increases. This large amount of heat will undoubtedly shorten the life span of the individual components and the product life span of the surveillance monitor as a whole.

Second, since all of the display screen, the central processing unit and the power supply are mounted in the housing to form an integral body, the conventional surveillance monitor becomes very heavy and bulky. This severely affects product transportation and storage requirements.

Third, since all of the display screen, the central processing unit and the power supply are mounted in the housing to form an integral body, when one of the components is out of order, it is very difficult for the relevant technicians to replace the defective components. The user probably has to ship the whole set of surveillance monitor to the manufacturer's warehouse and the manufacturer will need to disassemble the surveillance monitor and figure out what happen to the defective components.

### SUMMARY OF THE PRESENT INVENTION

The invention is advantageous in that it provides a surveillance monitor wherein a monitor assembly and a control hub thereof are positioned at a distance so as to allow convenient control of the surveillance monitor.

Another advantage of the invention is to provide a surveillance monitor in which the control hub is positioned at a distance from the monitor assembly, so that heat generated by each of these components are easily dissipated and does not affect each other. In other words, the present invention effectively resolves the overheat problem mentioned above for conventional surveillance monitors.

Another advantage of the invention is to provide a surveillance monitor in which the control hub is positioned at a distance from the monitor assembly, so that each of these components can be separately mounted to external fixtures at different locations. As such, the present invention is particularly suitable for supporting a wide range of surveillance applications without having the limitations mentioned above (i.e. the bulky size the heavy weight for conventional surveillance monitor).

Another advantage of the invention is to provide a surveillance monitor in which the control hub is positioned at a distance from the monitor assembly, so that each of these components can be separately and conveniently repaired when they become defective.

Additional advantages and features of the invention will become apparent from the description which follows, and may be realized by means of the instrumentalities and combinations particular point out in the appended claims.

According to the present invention, the foregoing and other objects and advantages are attained by providing a surveillance monitor, comprising:

a monitor assembly which comprises at least one display unit for displaying a predetermined image; and

a control hub, which comprises:

a control housing positioned at a distance from the monitor assembly; and

a control module electrically communicated with the monitor assembly, wherein the control module comprises a central processing unit and a control panel provided on the control housing, wherein the central processing unit is arranged to process video signals, and transmit the processed video signal to the monitor assembly for generating a corresponding video image on the monitor assembly, so that a user is able to control video display on the monitor assembly by conveniently controlling the control module which is distant away from the monitor assembly.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a front perspective view of a surveillance monitor according to a preferred embodiment of the present invention.

FIG. 2 is a rear perspective view of the surveillance monitor according to the above preferred embodiment of the present invention.

FIG. 3 is a schematic diagram of the surveillance monitor according to the above preferred embodiment of the present invention.

FIG. 4 is a schematic diagram of the control module according to the above preferred embodiment of the present invention.

FIG. 5 is another schematic diagram of the surveillance monitor according to the above preferred embodiment of the present invention.

FIG. 6 is block diagram of the surveillance monitor according to the above preferred embodiment of the present invention.

FIG. 7 is a schematic diagram of the surveillance monitor according to the above preferred embodiment of the present invention, illustrating that locking arrangement is used for adjustably locking the monitor assembly with respect to the control hub.

FIG. 8 is first alternative mode of the surveillance monitor according to the above preferred embodiment of the present invention.

FIG. 9 is a schematic diagram of the first alternative mode of the surveillance monitor according to the above preferred embodiment of the present invention.

FIG. 10 is a second alternative mode of the surveillance monitor according to the above preferred embodiment of the present invention.

FIG. 11 is a first schematic diagram of the second alternative mode of the surveillance monitor according to the above preferred embodiment of the present invention.

FIG. 12 is a second schematic diagram of the second alternative mode of the surveillance monitor according to the above preferred embodiment of the present invention.

FIG. 13 is a schematic diagram of the third alternative mode of the surveillance monitor according to the above preferred embodiment of the present invention.

FIG. 14 is an exploded perspective view of the third alternative mode of the surveillance monitor according to the above preferred embodiment of the present invention.

FIG. 15 is first perspective view of the third alternative mode of the surveillance monitor according to the above preferred embodiment of the present invention.

### DETAILED DESCRIPTION OF THE PREFERRED EMBODIMENT

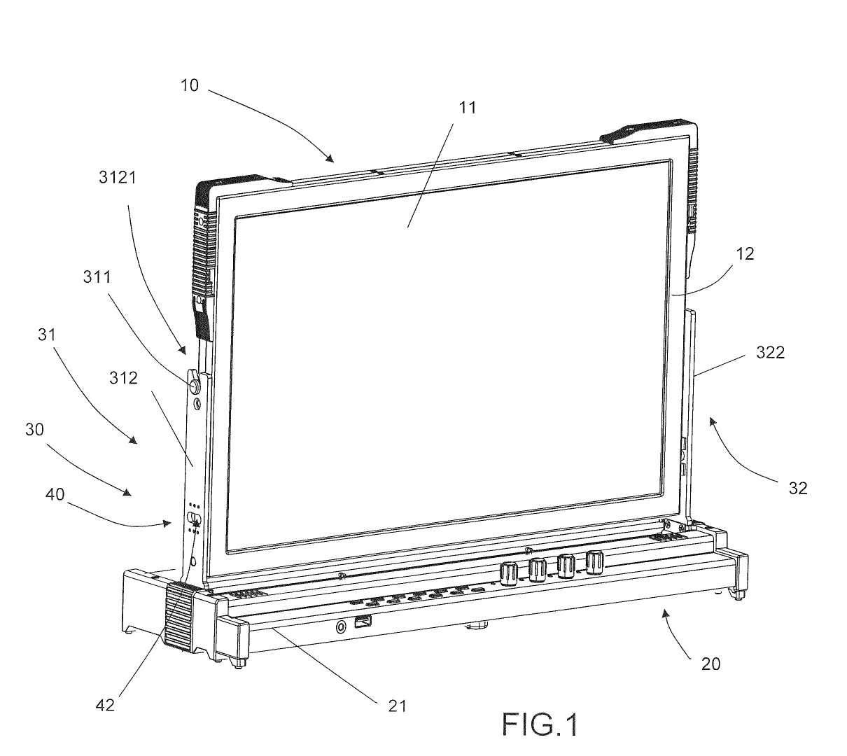

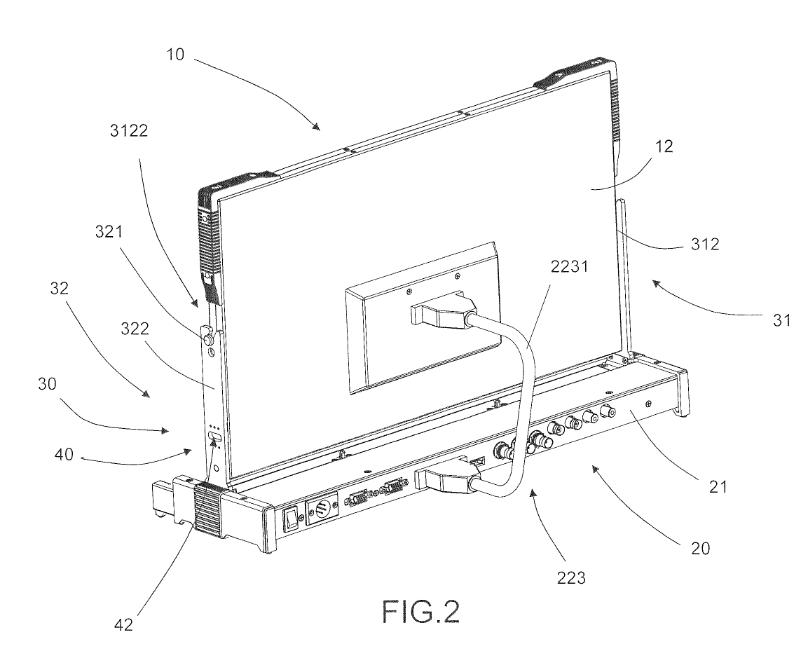

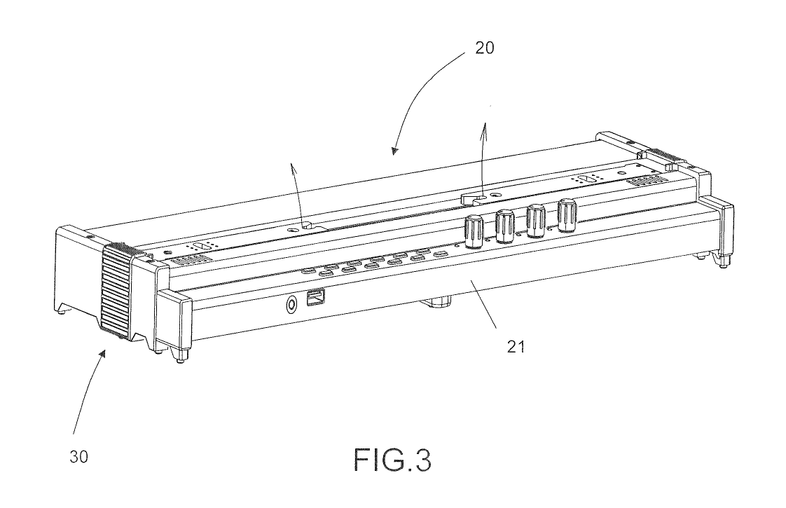

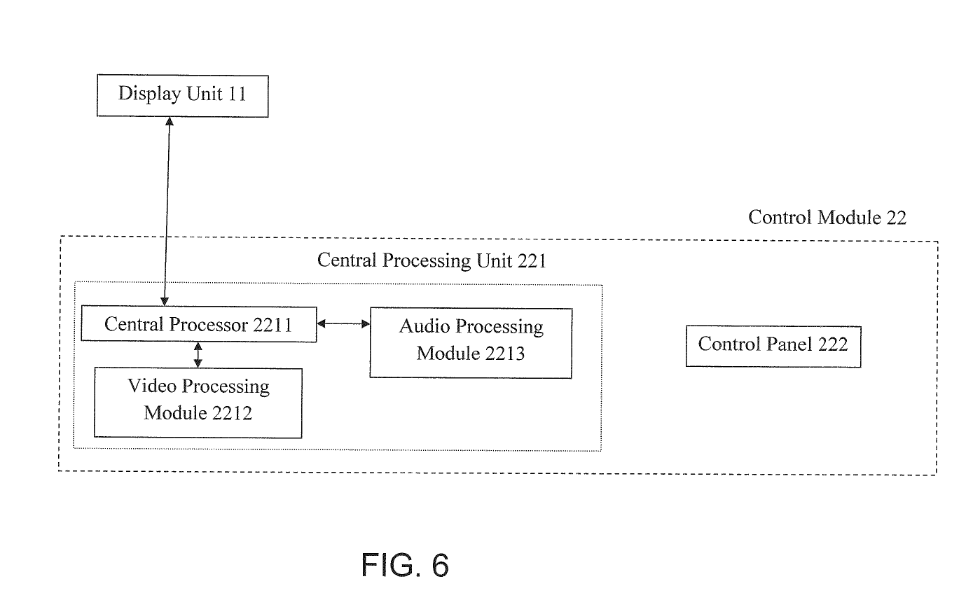

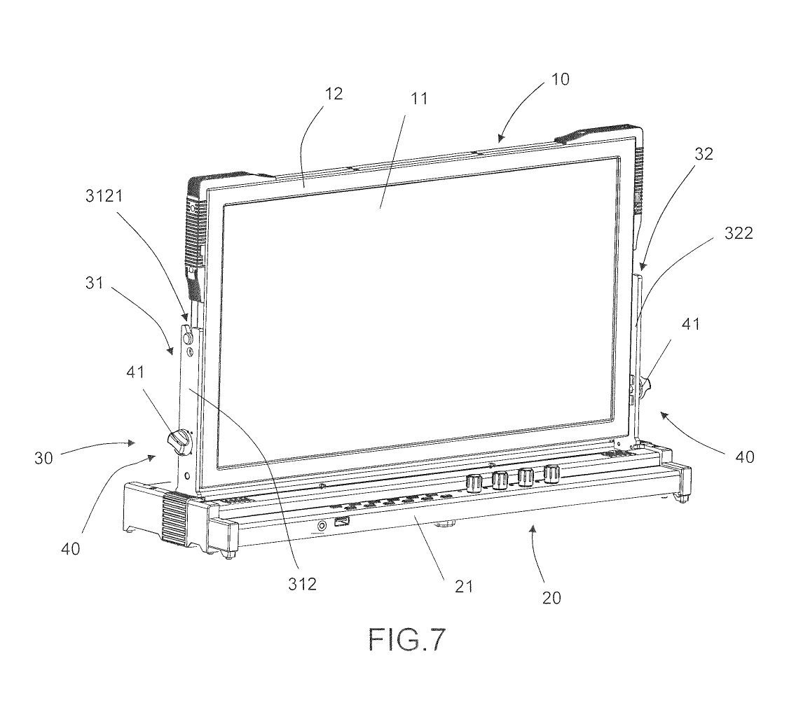

Referring to FIG. 1 to FIG. 7 of the drawings, a surveillance monitor according to a preferred embodiment of the present invention is illustrated, in which the surveillance monitor comprises a monitor assembly 10 and a control hub 20 comprising a control housing 21 and a control module 22.

The monitor assembly 10 comprises at least one display unit 11 for displaying a predetermined image. On the other hand, the control housing 21 is positioned at a distance from the monitor assembly 10.

The control module 22 is electrically communicated with the monitor assembly 10, wherein the control module 22 comprises a central processing unit 221 and a control panel 222 provided on the control housing 21, wherein the central processing unit 221 is arranged to process video signals, and transmit the processed video signal to the monitor assembly 10 for generating a corresponding video image on the monitor assembly 10, so that a user is able to control video display on the monitor assembly 10 by conveniently controlling the control module 22 which is distant away from the monitor assembly 10.

According to the preferred embodiment of the present invention, the monitor assembly 10 further comprises a monitor housing 12 for receiving the display unit 11, wherein the display unit 11 is embodied as a Liquid Crystal Display (LCD) for generating video image thereon. It is worth mentioning that, however, the display unit 11 can also be embodied as different kinds of displays, such as a LED display or a traditional CRT display.

On the other hand, the central processing unit 221 comprises a central processor 2211, a video processing module 2212 electrically connected to the central processor 2211 for processing video signal, and an audio processing module 2213 electrically connected to the central processor 2211 for processing audio signal.

The control module 22 further comprises a connection device 223 electrically connecting the monitor assembly 10 with the control hub 20 so as to electrically connect the monitor assembly 10 with the central processing unit 221, such that the processed video and audio signals can be transmitted to the monitor assembly 10 for delivering the corresponding video image and audible sound therefrom.

In this preferred embodiment, the connection device 223 comprises a connecting cable 2231 extending between the control module 22 and the monitor assembly 10 for transmitting electronic signals between the two components. Since the control hub 20 and the monitor assembly 10 are separately positioned at a distance, the heat generated by each of these components does not affect each other. This substantially resolves the overheat problem mentioned above. Moreover, each of the monitor assembly 10 and the control module 22 can be separately disassembled and repaired when their components become defective. It is worth mentioning that the connection device 223 may also be arranged to transmit the video and audio signals through wireless means instead of the connecting cable 2231.

The surveillance monitor further comprises a supporting frame 30 mounting the monitor assembly 10 with the control hub 20. It is important to mention that, however, each of the monitor assembly 10 and the control hub 20 can be separately mounted by any other means at different locations. The supporting frame 30 mentioned in this preferred embodiment is merely exemplary and does not intend to limit the spirit of the present invention.

The supporting frame 30 comprises a first and a second mounting frame 31, 32 provided at two opposed sides of the control housing 21, wherein the monitor housing 11 is arranged to be mounted at a position above the control housing 21. More specifically, the first mounting frame 31 comprises an first upper frame member 311 mounted on the a corresponding side of the monitor housing 12 and a first lower frame member 312 mounted on the corresponding side of the control housing 21, wherein the first upper frame member 311 and the first lower frame member 312 are arranged to adjustably mounted with each other for adjustably mounting the monitor housing 11 above the control housing 12 at a predetermined height. On the other hand, the second mounting frame 32 comprises an second upper frame member 321 mounted on the a corresponding side of the monitor housing 12 and a second lower frame member 322 mounted on the corresponding side of the control housing, wherein the second upper frame member 321 and the second lower frame member 322 are arranged to adjustably mounted with each other for adjustably mounting the monitor housing 11 above the control housing 12 at a predetermined height.

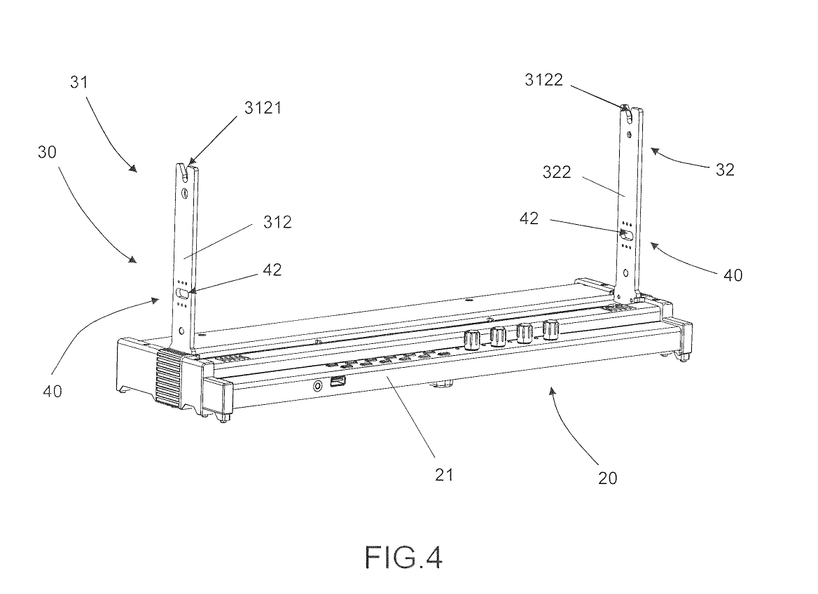

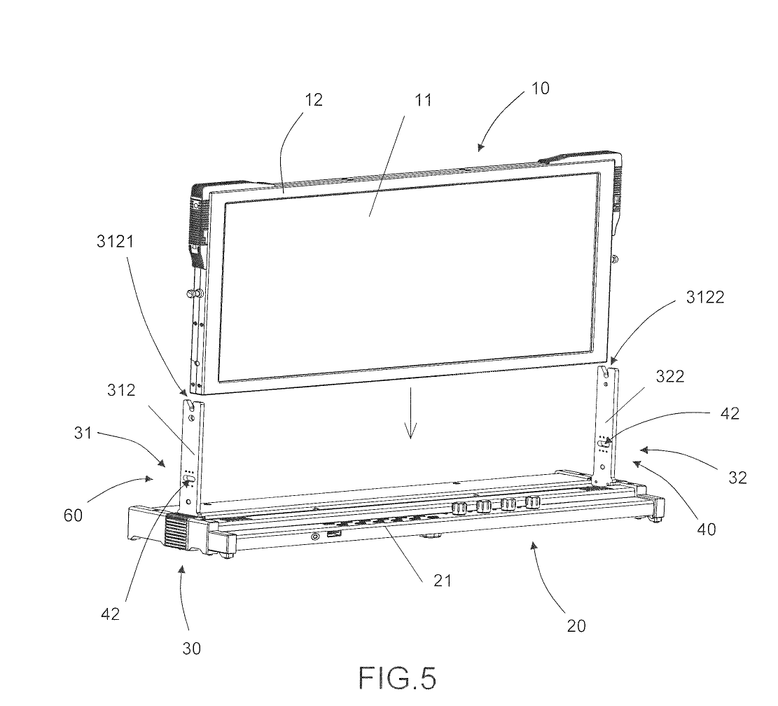

As shown in FIG. 4 to FIG. 5 of the drawings, each of the first lower frame member 312 and the second lower frame member 322 is elongated in shape and has one end mounted on the control housing 12 and another end extended from the control housing 12 to engage with the first upper frame member 311 and the second upper frame member 321 respectively. Moreover, each of the first and the second upper frame member 311, 321 is embodied as a connecting pin for detachably engaging with the first and the second lower frame member 312, 322 respectively. Thus, the first and the second lower frame member 312, 322 has a first and a second connecting slot 3121, 3122 respectively for detachably and rotatably engaging with the corresponding connecting pin.

Furthermore, surveillance monitor further comprises a locking arrangement 40 provided on the supporting frame 30 for selectively limiting a lateral rotational movement between the monitor assembly 10 and the control hub 20. The locking arrangement 40 comprises a plurality of locker knobs 41, and contains a plurality of locking holes 42 formed on the first lower frame member 312, the second lower frame member 322, and two sides of the monitor housing 12, wherein each of the locking holes 42 formed on the monitor housing 12 are aligned with the corresponding locking hole 42 forming on the first lower frame member 312 and the second lower frame member 322, wherein each of the corresponding locker knobs 41 is arranged to pass through the corresponding locking holes 42 for selectively locking a relative rotational movement between the monitor assembly 10 and the control hub 20.

It is worth mentioning that each of the first and the second lower frame member 312, 322 are pivotally connected to the control housing 21 so that each of the first and the second lower frame member 312, 322 can be pivotally moved and vertically extended from the control housing 21 to connect with the first and the second upper frame member 311, 321 respectively. However, when the supporting frame 30 is not in use, the first and the second lower frame member 312, 322 can be pivotally folded toward the control housing 21 to form a compact structure for easy storage.

In order to facilitate easy mounting of the monitor assembly 10 to the control hub 20, a width of the monitor housing 12 is slightly smaller than a distance between the first lower mounting frame 312 and the second lower mounting frame 322 so that the monitor housing 12 can be easily slide into the space between the first lower mounting frame 312 and the second lower mounting frame 322 in such a manner that the first and the second upper mounting frame 311, 321 are detachably and movably engaged with the first and the second lower mounting frame 312, 322 respectively.

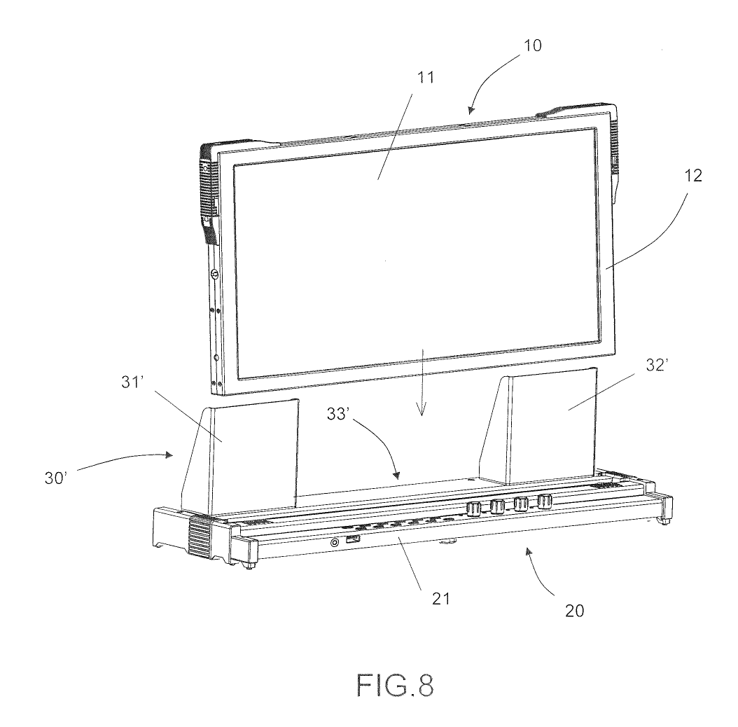

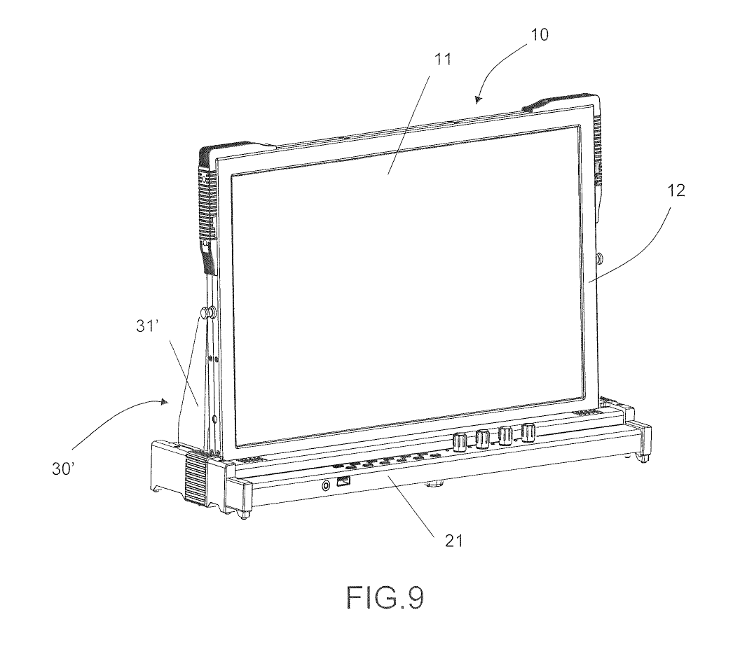

Referring to FIG. 8 to FIG. 9 of the drawings, a first alternative mode of the surveillance monitor according to the preferred embodiment of the present invention is illustrated. The first alternative mode is similar to the preferred embodiment, except the supporting frame 30′. According to the first alternative mode, the supporting frame 30′ comprises a first and a second mounting frame 31′, 32′ spacedly mounting on the control housing 21 of the control hub 20, and contains a mounting slot 33′ longitudinally and indently formed on a top side of the control housing 21, wherein the monitor housing 12 is detachably inserted into the mounting slot 33′ for connecting with the control housing 21. Each of the first mounting frame 31′ and the second mounting frame 32′ are mounted on the control housing 21 at a position which biases against a rear side of the monitor housing 12 for providing support to the monitor housing 12.

Note that each of the first and the second mounting frame 31′, 32′ is embodied as an L-shaped mounting panel which provide structural support to the monitor housing 12 when it is mounted on the control housing 21.

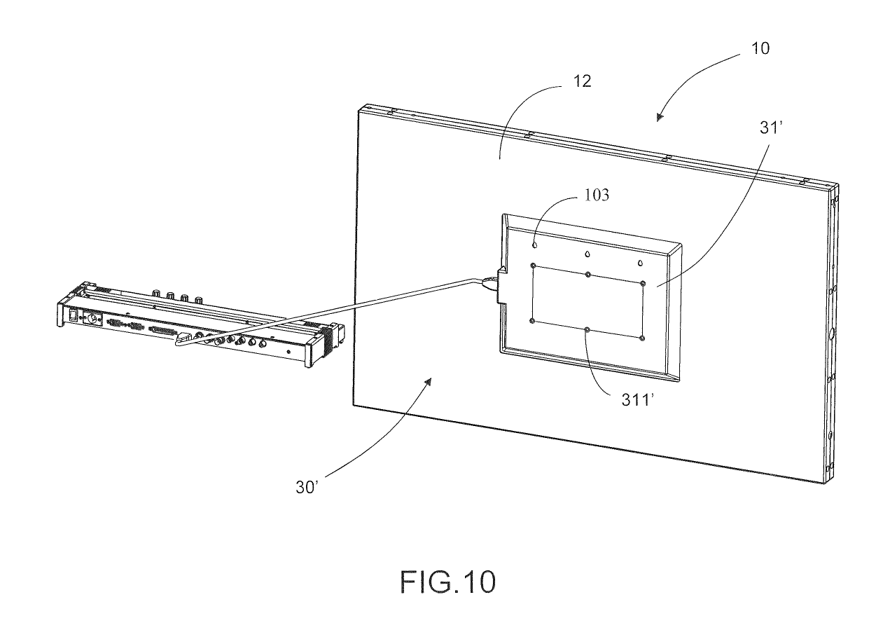

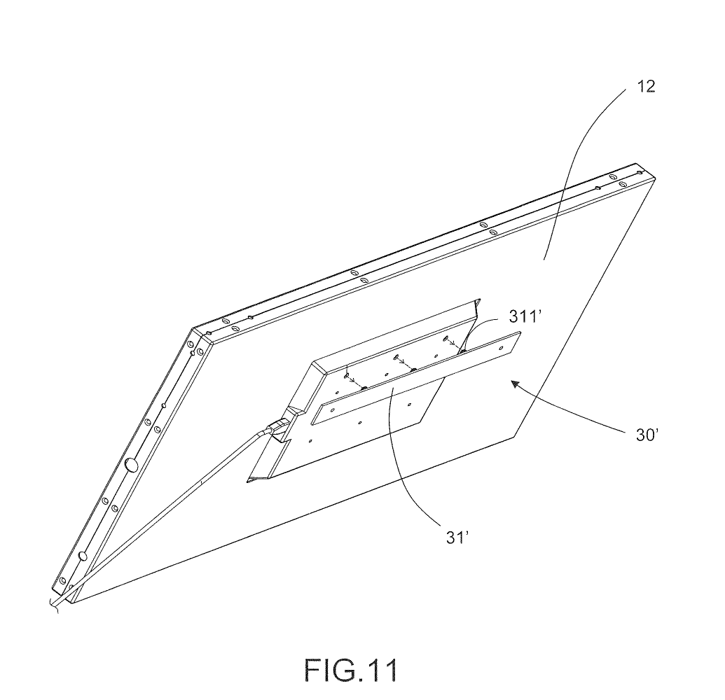

Referring to FIG. 10 to FIG. 11 of the drawings, a surveillance monitor according to a second alternative mode of the present invention is illustrated. The second alternative mode is similar to the preferred embodiment, except the supporting frame 30″. In the second alternative mode, the supporting frame 30″ is arranged to mount the monitor assembly 10 with an external fixture, and comprises a mounting panel 31″ mounted onto an external fixture, wherein the monitor housing 12 is detachably mounted onto the mounting panel 31″ (preferably through a plurality of connectors 311″) so as to mount the monitor housing to the external fixture, such as a wall.

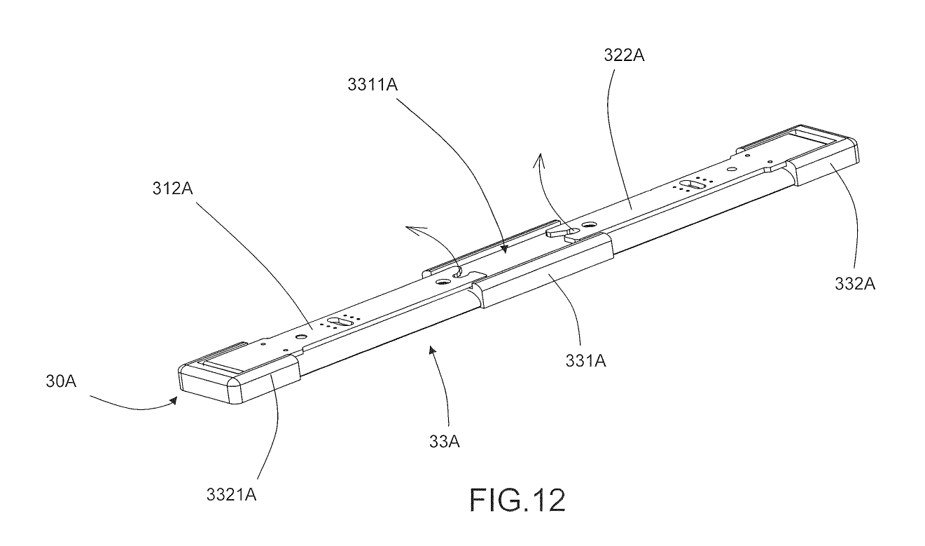

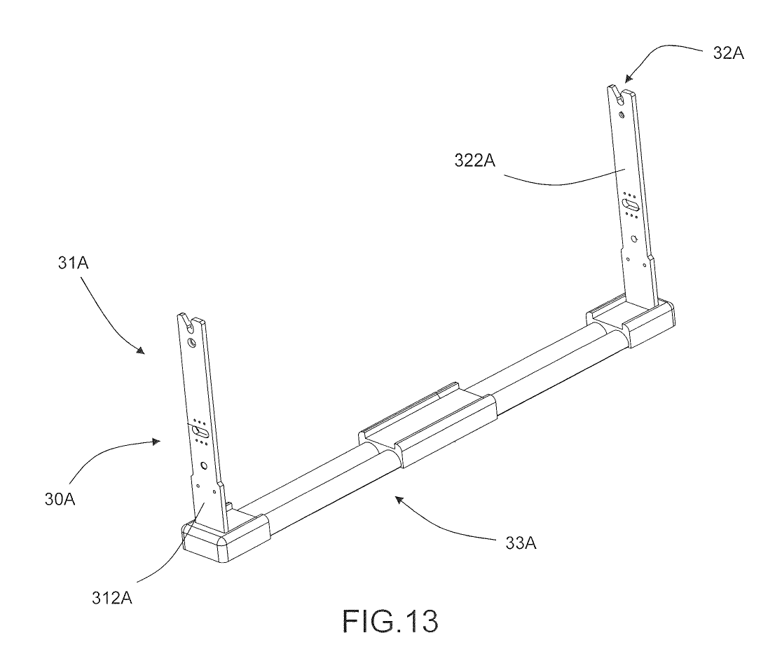

Referring to FIG. 12 to FIG. 15 of the drawings, a surveillance monitor according to a third alternative mode of the present invention is illustrated. The third alternative mode is similar to the preferred embodiment, except the supporting frame 30A. According to the third alternative mode, the supporting frame 30A comprises a base frame 33A, a first and a second mounting frame 31A, 32A provided at two opposed sides of the monitor housing 11A and mounted at two sides of the base frame 33A respectively. The first mounting frame 31A comprises an first upper frame member 311A mounted on the a corresponding side of the monitor housing 12 and a first lower frame member 312A mounted on the corresponding side of the base frame 33A, wherein the first upper frame member 311A and the first lower frame member 312A are arranged to adjustably mounted with each other for adjustably supporting the monitor housing 11A above the ground surface at a predetermined height.

On the other hand, the second mounting frame 32A comprises an second upper frame member 321A mounted on the a corresponding side of the monitor housing 12A and a second lower frame member 322A mounted on the corresponding side of the base frame 33A, wherein the second upper frame member 321A and the second lower frame member 322A are arranged to adjustably mounted with each other for adjustably mounting the monitor housing 11A above the ground surface at the predetermined height. Thus, the supporting frame 30A is arranged to support the monitor assembly 10A above a ground surface at the predetermined height.

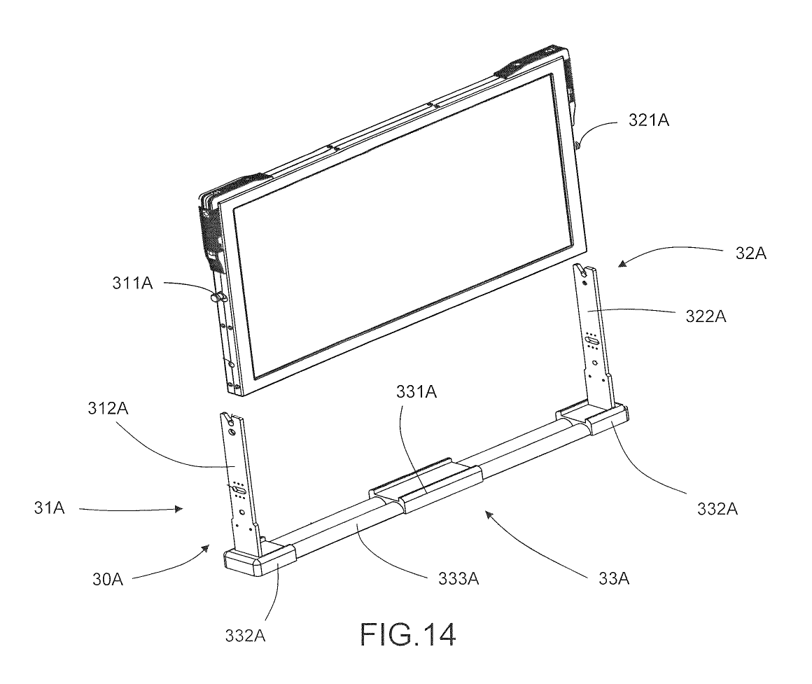

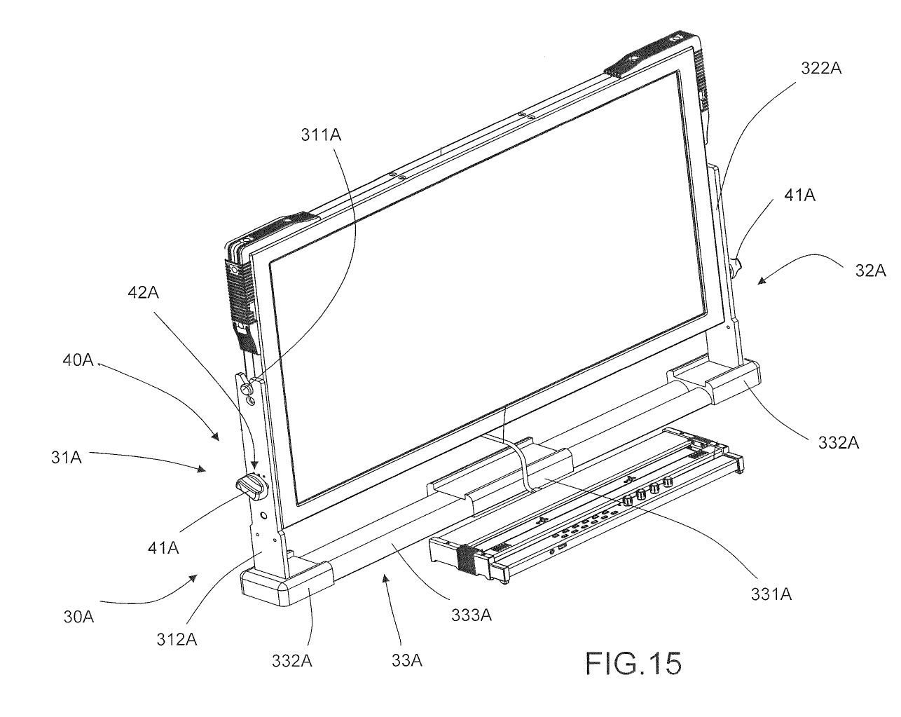

As shown in FIG. 14 to FIG. 15 of the drawings, each of the first lower frame member 312A and the second lower frame member 322A is elongated in shape and has one end mounted on the base frame 33A and another end extended from the base frame 33A to engage with the first upper frame member 311A and the second upper frame member 321A respectively. Moreover, each of the first and the second upper frame member 311A, 321A is embodied as a connecting pin for detachably engaging with the first and the second lower frame member 312A, 322A respectively. Thus, the first and the second lower frame member 312A, 322A has a first and a second connecting slot 3121A, 3122A respectively for detachably and rotatably engaging with the corresponding connecting pin.

Moreover, the base frame 33A comprises a main base member 331A, two side base members 332A movably and adjustably mounted at two sides of the main base member 331A, and a connecting base member 333A wherein the first and the second lower frame member 312A, 322A are extended from the side base members 332A respectively and connected to the main base member 331A through the connecting base member 333A.

Alternatively, as shown in FIG. 12 of the drawings, the main base member 331A has a sliding slot 3311A formed thereon, wherein each of the two side base members 32A are adapted to slidably and adjustably engage with the sliding slot 3311A so as to adjustably connect the two side base members 32A with the main base member 331A.

Furthermore, the surveillance monitor further comprises a locking arrangement 40A provided on the supporting frame 30A for selectively limiting a lateral rotational movement between the monitor assembly 10 and the control hub 20. The locking arrangement 40A comprises a plurality of locker knobs 41A, and contains a plurality of locking holes 42A formed on the first lower frame member 312A, the second lower frame member 322A, and two sides of the monitor housing 12, wherein each of the locking holes 42A formed on the monitor housing 12 are aligned with the corresponding locking hole 42A forming on the first lower frame member 312A and the second lower frame member 322A, wherein each of the corresponding locker knobs 41A is arranged to pass through the corresponding locking holes 42A for selectively locking a relative rotational movement between the monitor assembly 10A and the control huh 20.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A surveillance monitor, comprising:
a monitor assembly which comprises at least one monitor housing and a display unit for displaying a predetermined image; and
a control hub, which comprises:
a control housing positioned at a distance from said monitor assembly; and
a control module electrically communicated with said monitor assembly, wherein said control module comprises a central processing unit and a control panel provided on said control housing, wherein said central processing unit is arranged to process video signals, and transmit said processed video signal to said monitor assembly for generating a corresponding video image on said monitor assembly, so that a user is able to control video display on said monitor assembly by conveniently controlling said control module which is distant away from said monitor assembly.

2. The surveillance monitor, as recited in claim 1, wherein said central processing unit comprises a central processor, a video processing module electrically connected to said central processor for processing video signal, and an audio processing module electrically connected to said central processor for processing audio signal.

3. The surveillance monitor, as recited in claim 2, wherein said control module further comprises a connection device electrically connecting said monitor assembly with said control hub, such that said processed video and audio signals are transmitted to said monitor assembly for delivering said corresponding video image and audible signal.

4. The surveillance monitor, as recited in claim 3, wherein said connection device comprises a connecting cable extending between said control module and said monitor assembly for transmitting electronic signals between said control module and said monitor assembly.

5. The surveillance monitor, as recited in claim 3, further comprising a supporting frame mounting said monitor assembly with said control hub, wherein said supporting frame comprises a first and a second mounting frame provided at two opposed sides of said control housing, wherein said monitor housing is arranged to be mounted at a position above said control housing.

6. The surveillance monitor, as recited in claim 4, further comprising a supporting frame mounting said monitor assembly with said control hub, wherein said to supporting frame comprises a first and a second mounting frame provided at two opposed sides of said control housing, wherein said monitor housing is arranged to be mounted at a position above said control housing.

7. The surveillance monitor, as recited in claim 6, wherein said first mounting frame comprises a first upper frame member mounted on a corresponding side of said monitor housing and a first lower frame member mounted on a corresponding side of said control housing, wherein said first upper frame member and said first lower frame member are arranged to adjustably mounted with each other, wherein said second mounting frame comprises an second upper frame member mounted on said corresponding side of said monitor housing and a second lower frame member mounted said corresponding side of said control housing, wherein said second upper frame member and said second lower frame member are arranged to adjustably mounted with each other for adjustably mounting said monitor housing above said control housing at a predetermined height.

8. The surveillance monitor, as recited in claim 7, wherein each of said first lower frame member and said second lower frame member is elongated in shape and has one end mounted on said control housing and another end extended from said control housing to engage with said first upper frame member and said second upper frame member respectively, wherein each of said first and said second upper frame member comprises a connecting pin for detachably and rotatably engaging with said first and said second lower frame member respectively.

9. The surveillance monitor, as recited in claim 6, further comprising a locking arrangement provided on said supporting frame for selectively limiting a lateral rotational movement between said monitor assembly and said control hub.

10. The surveillance monitor, as recited in claim 8, further comprising a locking arrangement provided on said supporting frame for selectively limiting a lateral rotational movement between said monitor assembly and said control hub, wherein said locking arrangement comprises a plurality of locker knobs, and contains a plurality of locking holes formed on said first lower frame member said second lower frame member, and two sides of said monitor housing, wherein each of said locking holes formed on said monitor housing are aligned with said corresponding locking hole forming on said first lower frame member and said second lower frame member, wherein each of said corresponding locker knobs is arranged to pass through said corresponding locking holes for selectively locking a relative rotational movement between said monitor assembly and said control hub.

11. The surveillance monitor, as recited in claim 8, wherein each of said first and said second lower frame member are pivotally connected to said control housing so that each of said first and said second lower frame member are capable of pivotally moving and vertically extending from said control housing to connect with said first and said second upper frame member respectively when said surveillance monitor is in use, wherein said first and said second lower frame member are capable of pivotally folding toward said control housing when said supporting frame is not in use.

12. The surveillance monitor, as recited in claim 10, wherein each of said first and said second lower frame member are pivotally connected to said control housing so that each of said first and said second lower frame member are capable of pivotally moving and vertically extending from said control housing to connect with said first and said second upper frame member respectively when said surveillance monitor is in use, wherein said first and said second lower frame member are capable of pivotally folding toward said control housing when said supporting frame is not in use.

13. The surveillance monitor, as recited in claim 6, wherein each of said supporting frame comprises a first and a second mounting frame spacedly mounting on said control housing of said control hub, and contains a mounting slot longitudinally and indently formed on a top side of said control housing, wherein said monitor housing is detachably inserted into said mounting slot for connecting with said control housing, wherein each of said first mounting frame and said second mounting frame are mounted on said control housing at a position which biases against a rear side of said monitor housing for providing support to said monitor housing.

14. The surveillance monitor, as recited in claim 6, wherein said supporting frame is arranged to mount said monitor assembly with an external fixture, and comprises a mounting panel mounted onto an external fixture, wherein said monitor housing is detachably mounted onto said mounting panel so as to mount said monitor housing to said external fixture.

15. The surveillance monitor, as recited in claim 6, wherein said supporting frame comprises a base frame, a first and a second mounting frame provided at two opposed sides of said monitor housing and mounted at two sides of said base frame respectively, wherein said first mounting frame comprises an first upper frame member mounted on a corresponding side of said monitor housing and a first lower frame member mounted on said corresponding side of said base frame, wherein said first upper frame member and said first lower frame member are arranged to adjustably mounted with each other, wherein said second mounting frame comprises an second upper frame member mounted on said a corresponding side of said monitor housing and a second lower frame member mounted on said corresponding side of said base frame, wherein said second upper frame member and said second lower frame member are arranged to adjustably mounted with each other for adjustably mounting said monitor housing above said ground surface at said predetermined height.

16. The surveillance monitor, as recited in claim 15, wherein each of said first lower frame member and said second lower frame member is elongated in shape and has one end mounted on said base frame and another end extended from said base frame to engage with one of said first upper frame member and said second upper frame member respectively, wherein each of said first and said second upper frame member comprises a connecting pin for detachably engaging with said first and said second lower frame member respectively.

17. The surveillance monitor, as recited in claim 15, wherein said base frame comprises a main base member, two side base members movably and adjustably mounted at two sides of said main base member, and a connecting base member wherein said first and said second lower frame member are extended from said side base members respectively and connected to said main base member through said connecting base member.

18. The surveillance monitor, as recited in claim 17, further comprising a locking arrangement provided on said supporting frame, and comprises a plurality of locker knobs, and contains a plurality of locking holes formed on said first lower frame member, said second lower frame member, and two sides of said monitor housing, wherein each of said locking holes formed on said monitor housing are aligned with said corresponding locking hole forming on said first lower frame member and said second lower frame member, wherein each of said corresponding locker knobs is arranged to pass through said corresponding locking holes for selectively locking a relative rotational movement between said monitor assembly and said control hub

19. The surveillance monitor, as recited in claim 17, wherein said main base member has a sliding slot formed thereon, wherein each of said two side base members are adapted to slidably and adjustably engage with said sliding slot so as to adjustably connect said two side base members with said main base member.

20. The surveillance monitor, as recited in claim 19, further comprising a locking arrangement provided on said supporting frame, and comprises a plurality of locker knobs, and contains a plurality of locking holes formed on said first lower frame member, said second lower frame member, and two sides of said monitor housing, wherein each of said locking holes formed on said monitor housing are aligned with said corresponding locking hole forming on said first lower frame member and said second lower frame member, wherein each of said corresponding locker knobs is arranged to pass through said corresponding locking holes for selectively locking a relative rotational movement between said monitor assembly and said control hub.
